(19) United States
(12) Patent Application Publication
(10) Pub. No.: US 2016/0055572 A1
(43) Pub. Date: Feb. 25, 2016

(54) Processing Commodity Transaction and Logistics Solution

(71) Applicant: Alibaba Group Holding Limited, Grand Cayman (KY)

(72) Inventor: Yueyang Chen, Hangzhou (CN)

(21) Appl. No.: 14/830,134

(22) Filed: Aug. 19, 2015

(30) Foreign Application Priority Data
Aug. 19, 2014 (CN) 201410408992.1

(51) Int. Cl. G06Q 30/06; G06Q 10/08

(52) U.S. Cl. CPC G06Q 30/0635; G06Q 30/0639; G06Q 10/087

(57) ABSTRACT

Implementations herein relate to method and systems for processing transactions, managing logistics orders, and managing an inventory management system. A method may include receiving, by a computer device, a transaction request for an item from a user. The computing device may obtain location information and/or address information of the user and transmit a stock acquisition request for the item to an inventory management system. The stock acquisition request may include the location information and/or the address information of the user. The computing device may further receive inventory information and warehouse identification information from the inventory management system and determine that the item is in real stock or virtual stock based on the inventory information. If the item is in real stock or virtual stock, the computing device may generate a corresponding trading order and a corresponding logistics order and transmit the logistics order to the logistics management system.

### CROSS REFERENCE TO RELATED PATENT APPLICATIONS

This application claims priority to Chinese Patent Application No. 201410408992.1, filed on Aug. 19, 2014, entitled “Methods and Systems for Processing Commodity Transaction and Logistics Solution,” which is hereby incorporated by reference in its entirety.

### TECHNICAL FIELD

The present disclosure relates to transaction processing technologies and, more specifically, to methods and systems for processing transactions, managing logistics orders, and managing an inventory management system.

### BACKGROUND

To improve user shopping experience, online malls (e.g., TAOBAO™ and TIANMAO™) place items into logistics warehouses in advance. When users browse through a website of an online mall, the online mall may assign a shipping logistics warehouse to each of the users based on their addresses. The online mall may also provide a number of inventory including the item. If the inventory number is sufficient, a logistics order may be generated after the users make payments. The online mall may ship the item based on the logistics order associated with the logistics warehouse.

Under the current techniques, there are two solutions to address problems in processing transactions and logistics orders. As for the first solution, the normal sales may proceed for the physical commodities as follows. (1) The merchants may reserve logistics warehouses (distributed multiple positions in a country). (2) The online mall may transfer items to logistics warehouses and complete entry of the inventory. (3) Users may browse websites and select items, and the online mall may therefore generate trading orders after payments are received. (4) The online mall may automatically get a list of corresponding logistics warehouse shipping addresses. The online mall may select an appropriate logistics warehouse for the items and record codes of logistics warehouses in the logistics orders. (5) The online mall may generate logistics orders and record codes of the logistics warehouses in the logistics orders. (6) The online mall may ship items of logistics orders based on the codes.

The second option is a solution for future sales. (1) The merchants may reserve logistics warehouses. (2) A pre-logistics warehouse may be built for the merchants. (3) The merchants may record the inventory of items in the pre-logistics warehouse. (4) Users may purchase items of future sales, and the coverage area of the user's shipping address may match the pre-futures logistics warehouse shipping address. (5) Logistics orders are generated after receiving deposit, and the logistics warehouse is recorded. (6) The users may pay the balance of logistics order, and the online mall may record pre-logistics warehouse and ship the items. Shipping may be performed in three ways. After the final payment, the online mall may ship items automatically. If the items are out of stock, the order may be placed on hold for the next two shipping methods. B. After entry of inventory is completed, triggering the shipping of the items. C. The shipping of the items may be triggered in a predetermined time period.

The techniques described above have obvious problems. While future sales solve some problems, trading volume of the future sales remains low and funds, as well as logistical resources, have been wasted. For further sales, entry of inventory is closely related to shipping times. Compared to spot sales, items of future sales may not be shipped after users make payments. The items are shipped after they enter the inventory. This has a great impact on the volume of transactions. In addition, merchants have limited ways to perform future sales and therefore the volume of transactions is low. There are concepts of logistics sub-warehouses and logistics main warehouses for logistics warehouses. A logistics main warehouse may include multiple logistics sub-warehouses. Allocation between the logistics main warehouse and the logistics sub-warehouse also has problems. For example, for items purchased by users, the logistics sub-warehouse may not have them while the logistics main warehouse may. Thus, the items must be allocated from the logistics main warehouse to the logistics sub-warehouse. This increases logistics costs and results in wasting funds.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

Implementations of the present disclosure relate to systems and methods for processing transactions, managing inventory management system, and managing logistics orders. The implementations herein solve problems under conventional techniques such as increasing transaction costs and having low logistics volumes. This Summary is not intended to identify all key features or essential features of the claimed subject matter, nor is it intended to be used alone as an aid in determining the scope of the claimed subject matter.

In implementations, a method for processing transactions may include receiving, by a computer device, a transaction request for an item from a user. The computing device may obtain location information and/or address information of the user, and transmit a stock acquisition request for the item to an inventory management system. In these instances, the stock acquisition request includes the location information and/or the address information of the user. The computing device may further receive inventory information and warehouse identification information from the inventory management system, and determine that the item is in real stock or virtual stock based on the inventory information. If the item is in real stock or virtual stock, the computing device may generate a corresponding trading order and a corresponding logistics order and transmit the logistics order to the logistics management system.

For example, the computing device may determine whether the item is in real stock based on the inventory information. If the item is in real stock, the computing device may generate a real stock trading order and a real inventory logistics order for the item. If the item is not in real stock, the computing device may determine whether the item is in virtual stock based on the inventory information. If the item is in virtual stock, the computing device may generate a virtual stock trading order and a virtual inventory logistics order for the item.

In implementations, the real stock trading order and the real inventory logistics order may include warehouse identification information corresponding to the item.

In implementations, the virtual stock trading order and the virtual inventory logistics order may include virtual inventory identification information and the warehouse identification information that correspond to the item. In these instances, the virtual inventory identification information may include a tag indicating a shipping order of the virtual inventory logistics order. The inventory information may include real stocking information and virtual stocking information.

For instances, the location information may include at least one of IP address information, GPS location information, or location information of a base station. The address information may include a shipping address of the user.

In implementations, a system for processing transactions may include a transaction request receiving module configured to receive a transaction request for an item from a user, an information acquisition module configured to obtain location information and/or address information of the user, and a stock acquisition request transmitting module configured to transmit a stock acquisition request for the item to an inventory management system. In these instances, the stock acquisition request may include the location information and/or the address information of the user. The system may further include an inventory information receiving module configured to receive inventory information and warehouse identification information from the inventory management system, and a stock judgment module configured to determine that the item is in real stock or virtual stock based on the inventory information. If the item is in real stock or virtual stock, the order generating module may generate a corresponding trading order and a corresponding logistics order, and a logistics order transmission module configured to transmit the logistics order to the logistics management system.

In implementations, the stock judgment module may include a real stock judgment submodule configured to determine whether the item is in real stock based on the inventory information. If the item is in real stock, a real stock order generation submodule may generate a real stock trading order and a real inventory logistics order for the item. If the item is not in real stock, a virtual stock judgment submodule may determine whether the item is in real stock based on the inventory information. If the item is in virtual stock, a virtual stock order generation sub-module may generate a virtual stock trading order and a virtual inventory logistics order for the item.

In implementations, a method for managing an inventory system may include receiving, by a computing device, a stock acquisition request for an item from a commodity trading system. The stock acquisition request may include the location information and/or the address information of the user. The computing device may parse the location information and/or the address information of the user from the stock acquisition request, and obtain a logistics warehouse list including multiple logistics warehouses covering the location information and/or the address information of the user. Further, the computing device may select a logistics warehouse form the multiple logistics warehouses that has a shortest distance from a location indicated in the location information and/or the address information of the user, designate the logistics warehouse as a candidate logistics warehouse, obtain inventory information of the candidate logistics warehouse, and transmit the inventory information to the commodity trading system.

In implementations, the computing device may obtain warehouse identification information of the candidate logistics warehouse, and transmit the warehouse identification information to the commodity trading system. The warehouse identification information may include a warehouse code of the candidate logistics warehouse. After transmitting the inventory information to the commodity trading system, the computing device may update the inventory information of the candidate logistics warehouse.

In implementations, a system for managing an inventory system may include a stock acquisition request transmitting module configured to receive a stock acquisition request for an item from a commodity trading system. The stock acquisition request includes the location information and/or the address information of the user. The system may further include a parsing module configured to parse the location information and/or the address information of the user from the stock acquisition request, a logistics warehouse list acquisition module configured to obtain a logistics warehouse list including multiple logistics warehouses covering the location information and/or the address information of the user, and a logistics warehouse selecting module configured to select a logistics warehouse form the multiple logistics warehouses that has a shortest distance from a location indicated in the location information and/or the address information of the user; designate the logistics warehouse as a candidate logistics warehouse. The system may further include an inventory information acquisition module configured to obtain inventory information of the candidate logistics warehouse, an inventory information transmission module configured to transmit the inventory information to the commodity trading system.

In implementations, the system may further include a warehouse identification information acquisition module configured to obtain warehouse identification information of the candidate logistics warehouse, and a warehouse identification information transmission module configured to transmit the warehouse identification information to the commodity trading system. In implementations, the system may further include a stock information update module configured to update the inventory information of the candidate logistics warehouse.

In implementations, a method for managing orders may include receiving, from a computing device, a reservation request to logistics warehouses from a merchant. The computing device may retrieve reservation information of the merchant of the logistics warehouses to generate warehouse orders. The warehouse orders may include real warehouse orders and virtual warehouse orders. The computing device may transmit the warehouse orders to an inventory management system corresponding to the warehouse orders, receive a real inventory logistics order or a virtual inventory logistics order, parse the real inventory logistics order or the virtual inventory logistics order to obtain corresponding warehouse identification information, and process the real inventory logistics order or the virtual inventory logistics order based on the warehouse identification information. For instance, the logistics warehouses may include logistics main warehouses and the logistics sub-warehouses.

In implementations, the computing device may further receive the reservation request to the logistics main warehouses from the merchant and receiving the reservation request to the logistics sub-warehouse from the merchant.

In implementations, the computing device may receive a stocking confirmation of the warehouse order or the virtual warehouse orders from the inventory management system, and update the inventory information of the item in the logistics warehouses corresponding to the real warehouse orders or the virtual warehouse orders. In these instances, the inventory information may include real stocking information and virtual stocking information.

In implementations, the computing device may generate a message indicating that the virtual inventory logistics order is in stock, parse virtual inventory identification information of the virtual inventory logistics order from the virtual inventory logistics order after receiving the message, and determine a shipping order based on the virtual inventory identification information of the virtual inventory logistics order. In these instances, the virtual inventory identification information may include a tag indicating the shipping order of the virtual inventory logistics order.

In implementations, a device for managing orders may include a reservation request receiving module configured to receive a reservation request to logistics warehouses from a merchant, and a booking information acquisition module configured to retrieve reservation information of the merchant of the logistics warehouses to generate warehouse orders. The warehouse orders may include real warehouse orders and virtual warehouse orders.

In implementations, the device may further include a warehouse order generation module configured to transmit the warehouse orders to an inventory management system corresponding to the warehouse orders, a logistics order receiving module configured to receive a real inventory logistics order or a virtual inventory logistics order, and a logistics order analysis module configured to parse the real inventory logistics order or the virtual inventory logistics order to obtain corresponding warehouse identification information. The device may further include a delivery processing module configured to process the real inventory logistics order or the virtual inventory logistics order based on the warehouse identification information.

In implementations, the device may further include a warehousing confirmation message receiving module configured to receive a stocking confirmation of the warehouse order or the virtual warehouse orders from the inventory management system, and an inventory updating module configured to update the inventory information of the item in the logistics warehouses corresponding to the real warehouse orders or the virtual warehouse orders. The inventory information may include real stocking information and virtual stocking information.

Compared with the prior art, one aspect of the present disclosure has various advantages. For example, a method for processing transactions may include receiving a transaction request for an item from a user, obtain location information and/or address information of the user, and transmit a stock acquisition request for the item to an inventory management system. The stock acquisition request includes the location information and/or the address information of the user. The method may further include receiving inventory information and warehouse identification information from the inventory management system, determining that the item is in real stock or virtual stock based on the inventory information, generating a corresponding trading order and a corresponding logistics order, and transmitting the logistics order to the logistics management system.

The implementations herein may process transactions including various sales models. For example, the models may include spot sales and future sales. As compared to a single commodity future sales or spot sales, the implementations herein increases volumes of transactions.

In implementations, a method for managing logistics may include receiving a reservation request to logistics warehouses from a merchant, and retrieve reservation information of the merchant of the logistics warehouses to generate warehouse orders. The warehouse orders may include real warehouse orders and virtual warehouse orders. The method may further include transmitting the warehouse orders to an inventory management system corresponding to the warehouse orders, receiving a real inventory logistics order or a virtual inventory logistics order, parsing the real inventory logistics order or the virtual inventory logistics order to obtain corresponding warehouse identification information, and processing the real inventory logistics order or the virtual inventory logistics order based on the warehouse identification information.

When ordering items from the logistics warehouses, a merchant may order from the logistics main warehouses and the logistics sub-warehouses. The logistics main warehouses may allot items to the logistics sub-warehouses. This avoids lacking of stock in the logistics sub-warehouses and expenses for transforming items from the logistics main warehouses to the logistics sub-warehouses, therefore saving logistics resources.

### BRIEF DESCRIPTION OF THE DRAWINGS

The Detailed Description is described with reference to the accompanying figures. The use of the same reference numbers in different figures indicates similar or identical items.

FIG. 1 is a flow chart of an illustrative process for processing transactions.

FIG. 2 is a schematic diagram of an illustrative computing architecture that enable processing transactions.

FIG. 3 is a flow chart of an illustrative process for managing an inventory management system.

FIG. 4 is a schematic diagram of an illustrative computing architecture that enable managing an inventory management system.

FIG. 5 is a flow chart of an illustrative process for managing logistics orders.

FIG. 6 is a schematic diagram of an illustrative computing architecture that enable managing logistics orders.

### DETAILED DESCRIPTION

In the following description, numerous specific details are set forth in order to fully understand the present disclosure. However, the present disclosure may be implemented in many other ways than described herein, and those skilled in the art can make similar changes without departing from the present disclosure. This disclosure is therefore not limited to the specific embodiments disclosed below.

Implementations herein relate to methods, devices, and systems for processing transactions, managing inventory management systems, and managing logistics.

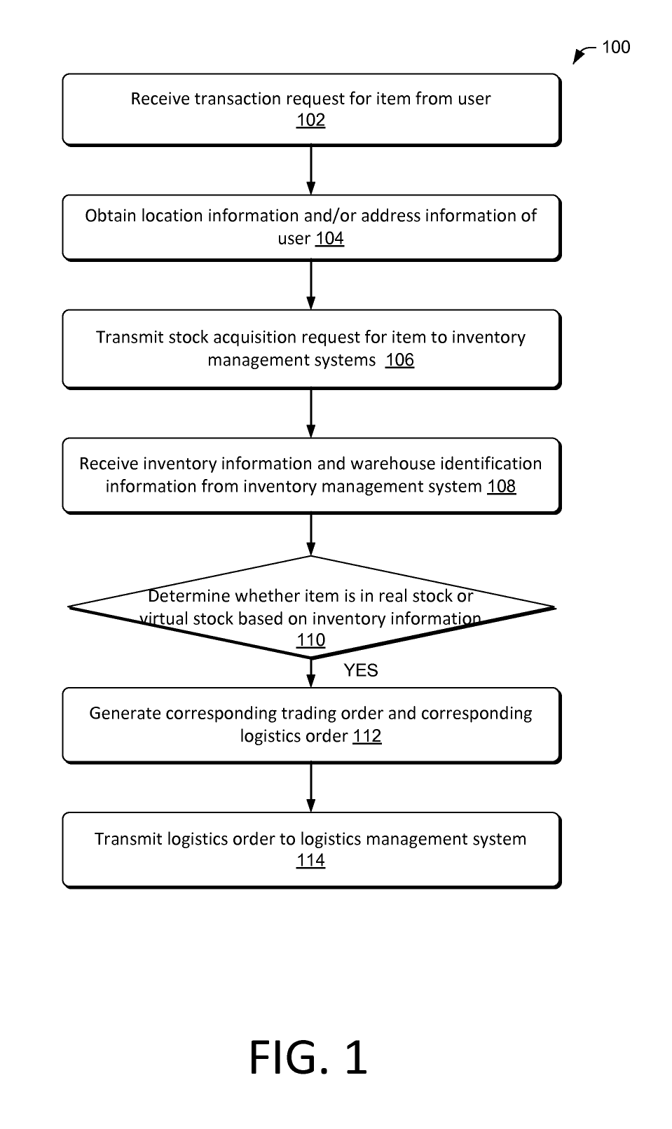

FIG. 1 is a flow chart of an illustrative process for processing transactions. At 102, a computing device (e.g., a server) may receive a transaction request for an item from a user device associated with a user. In implementations, the item may be related to appliances. It should be noted that the item is not limited to household appliances, but also other kinds of goods and/or service, such as audio books, clothing, electronics and household merchandises, etc. This is not limited by the present disclosure.

The user may include a consumer of an online mall and those who are involved the transactions. This is not limited by the present disclosure.

The transaction request may include an operational instruction that is sent from the user via a client terminal to the online mall. Accordingly, the operational instruction may be received from the client terminal. The operational instruction may include instruction information from PC terminals that are generated by mouse events and/or device touch at the PC terminals.

The operational instruction may include instructions issued by the user through other terminal equipment. This is not limited by the present disclosure.

At 104, the computing device may obtain location information and/or address information of the user. After the computing device receives the transaction request, the computing device may process the transaction request. For example, the computing device may show details of the appliances to the user, or show appliances stock information to the user.

In implementations, the computing device may obtain inventory information of the item based on the location information and/or address information of the user. Further, the computing device may obtain information of logistics warehouse corresponding to the location information. The location information of the logistics warehouse may indicate that a shipping address covers the location information.

The computing device may designate the logistics warehouse closest to the location information as a candidate logistics warehouse. The computing device may choose the candidate logistics warehouse based on the location information.

In implementations, the computing device may obtain the location information and the address information and then determine the candidate logistics warehouse based on a combination of the location information and the address information.

The location information may include at least one of IP address information, GPS location information, or location information of a base station. In addition, the location information may include other data to determine location information of the user. The address information may include a shipping address of the user and other data to determine geographic information of the user. This is not limited by the present disclosure.

At 106, the computing device may transmit a stock acquisition request for the item to an inventory management systems. The stock acquisition request includes the location information and/or the address information of the user. The inventory management system manages and maintains the online mall inventory information for all items. The inventory management system may determine inventory information based on the location information and/or address information. In implementations, the stock acquisition request may include the location information and the address information of the user.

The stock acquisition request may be transmitted to inventory management system to obtain the inventory information of the item. The operations 102 and 104 may be implemented after the inventory information of the item is prepared. For example, the operations 102 and 104 may be implemented after the address information and/or the location information of the user is obtained.

In implementations, the stock acquisition request may be transmitted to the inventory management system to obtain the inventory information of the item based on the location information and/or the inventory information. The computing device may then obtain the inventory information of the item and present the inventory information of the item to the user.

For example, the user may log into an account associated with the online mall and a system associated with the online mall may have the address information of the user. The address information of the user may be transmitted to the inventory management system. In another example, the user does not log into the online mall, or while the user logs into the account, the stored address information of the user is inconsistent with a current address of the user. Accordingly, the stock acquisition request is transmitted to the inventory management system and may include the location information and/or the address information. The stock acquisition request may be transmitted to the inventory management system in other ways. This is not limited by the present disclosure.

At 108, the computing device may receive inventory information and warehouse identification information from the inventory management system. The inventory management system may provide the inventory information and warehouse identification information from the inventory management system. For example, the inventory information may include real stocking information and virtual stocking information.

The implementations herein may process transactions including various sales models. The model may include spot sales and future sales. For example, for home appliances in the online mall, users may not only directly purchase items in stock and make payment, but also pay a deposit for the home appliances and make payment later on. In response to these two different sales models, there are two stocks for the same appliances. One is actual existence of the inventory information in the logistics warehouse, namely: real inventory information corresponding to the spot sales model. Another one is non-existence of the inventory information in the logistics warehouse, namely: virtual inventory information corresponding to the spot sales model. The virtual inventory information may indicate a number of sales determined by the merchant before the item is out of the manufacturer.

The warehouse identification information may include a warehouse code of the candidate logistics warehouse. The warehouse identification information is used to determine the logistics warehouse corresponding to the item. Other information may also be used to determine the corresponding relationship between the item and the logistics warehouse. This is not limited by the present disclosure.

After the address information and/or the location information of the user is obtained, the computing device may process the transaction request. Before a trading order is generated, a sale model of the item may be determined based on the inventory information: a spot sales model or future sales model. Different sales models correspond to different orders.

The following implementations relate to determination of sales models, and generation of an order corresponding to the sales model.

At 110, the computing device may determine that the item is in real stock or virtual stock based on the inventory information. There is an order of priority based on the presence of the real inventory information and virtual inventory information in the online mall. The real stock has higher priority than the priority of the virtual stock.

The computing device may determine whether the item is in real stock based on the inventory information. If the item is not in real stock, the computing device may determine whether the item is in virtual stock based on the inventory information. If the item is in real stock and in virtual stock, the transactions on items in real stock are processed first. In other words, the spot sales are processed if the item is in real stock and virtual stock. If the transactions of the items in real stock and virtual stock are both processed or the item is not in real stock, the transaction of items in the virtual stock are processed. In other words, the future sales are processed if the item is not in real stock. The determining that the item is in real stock or virtual stock based on the inventory information may include determine whether the item is in real stock based on the inventory information.

If the item is in real stock, the computing device may generate a real stock trading order and a real inventory logistics order for the item. If the item is not in real stock, the computing device may determine whether the item is in virtual stock based on the inventory information. If the item is in virtual stock, the computing device may generate a virtual stock trading order and a virtual inventory logistics order for the item.

The real inventory logistics order or the virtual inventory logistics order may include warehouse identification information of the item. The warehouse identification information may include a warehouse code of the candidate logistics warehouse. Other information may also be used to correspond to the logistics warehouse processing the shipping of the item. This is not limited by the present disclosure.

At 112, the computing device generates a corresponding trading order and a corresponding logistics order. In these instances, the item is in real stock or virtual stock. If the item is in real stock, the computing device may generate a real stock trading order and a real inventory logistics order for the item. The real stock trading order and the real inventory logistics order may correspond to the spot sales model. If the item is not in real stock but in virtual stock, the computing device may generate a virtual stock trading order and a virtual inventory logistics order for the item. The virtual stock trading order and the virtual inventory logistics order may correspond to the future sales model.

The virtual stock trading order and the virtual inventory logistics order may include virtual inventory identification information and the warehouse identification information that corresponds to the item. The purpose for recording the virtual stocking information is provided as follow.

The item in virtual stock cannot be shipped before the item is in stock (e.g., entry of the logistics warehouse). Therefore, the virtual inventory logistics order of the item is pending before the entry of the logistics warehouse. To ensure quality of service, after the entry of the logistics warehouse, the transaction of items in the virtual stock may be processed based on the order that the virtual inventory logistics order is generated. The virtual inventory logistics order is processed for shipping first if the virtual inventory logistics order is generated first. The virtual inventory logistics order is processed for shipping later if the virtual inventory logistics order is generated later. The virtual inventory identification information may be used as a tag indicating a shipping order of the virtual inventory logistics order. Other indicators may also be used to shipping order of the virtual inventory logistics order. This is not limited by the present disclosure.

At 114, the computing device may transmit the logistics order to the logistics management system after the computing device generates the real stock trading order and the real inventory logistics order or the virtual stock trading orders and the virtual inventory logistics order.

The real inventory logistics order or the virtual inventory logistics order is transmitted to the inventory management system. The logistics management system may process the real inventory logistics order or the virtual inventory logistics order to ship the orders accordingly.

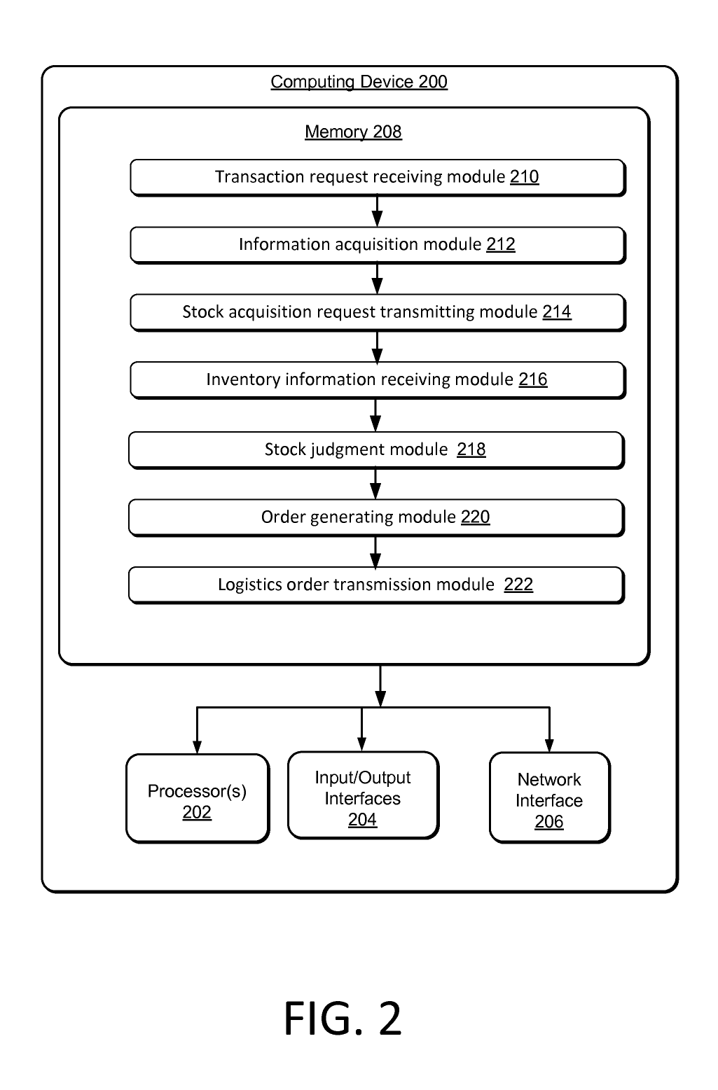

FIG. 2 is a schematic diagram of an illustrative computing architecture that enable processing transactions. The computing device 200 may be a user device or a server for processing transactions. In an exemplary configuration, the computing device 200 may include one or more processors 202, input/output interfaces 204, network interface 206, and memory 208.

The memory 208 may include computer-readable media in the form of volatile memory, such as random-access memory (RAM) and/or non-volatile memory, such as read only memory (ROM) or flash RAM. The memory 208 is an example of computer-readable media.

Computer-readable media may include volatile and non-volatile, removable and non-removable media implemented in any method or technology for storage of information such as computer readable instructions, data structures, program modules, or other data. Examples of computer storage media include, but are not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. As defined herein, computer-readable media does not include transitory media such as modulated data signals and carrier waves.

Turning to the memory 208 in more detail, the memory 208 may include a transaction request receiving module 210, an information acquisition module 212, a stock acquisition request transmitting module 214, an inventory information receiving module 216, a stock judgment module 218, an order generating module 220, and a logistics order transmission module 222.

The transaction request receiving module 210 may receive a transaction request for an item from a user. The information acquisition module 212 may obtain location information and/or address information of the user. The stock acquisition request transmitting module 214 may transmit a stock acquisition request for the item to an inventory management systems. The stock acquisition request may include the location information and/or the address information of the user. The inventory information receiving module 216 may receive inventory information and warehouse identification information from the inventory management system. The stock judgment module 218 may determine whether the item is in real stock or virtual stock based on the inventory information. If the item is in real stock or virtual stock, the order generating module 220 may generate a corresponding trading order and a corresponding logistics order.

The logistics order transmission module 222 may transmit the logistics order to the logistics management system. The stock judgment module 218 may include a real stock judgment submodule configured to determine whether the item is in real stock based on the inventory information.

If the item is in real stock, a real stock order generation submodule may generate a real stock trading order and a real inventory logistics order for the item. If the item is not in real stock, the virtual stock judgment submodule may determine whether the item is in real stock based on the inventory information. If the item is in virtual stock, a virtual stock order generation sub-module may generate a virtual stock trading order and a virtual inventory logistics order for the item.

The implementations further relate to methods for managing an inventory system and processing transactions.

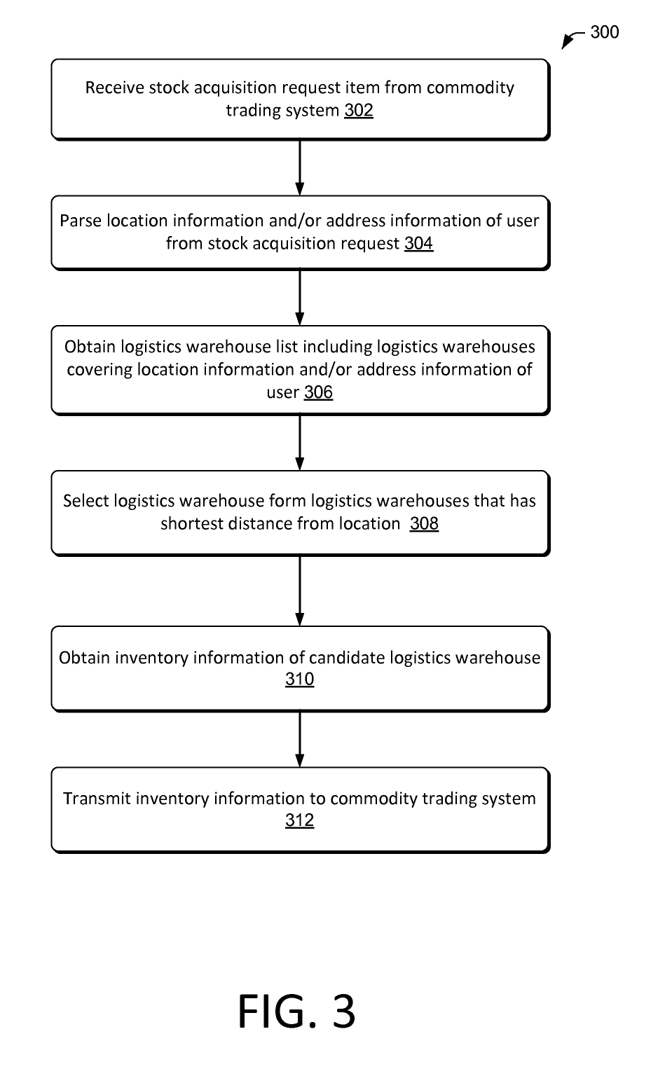

FIG. 3 is a flow chart of an illustrative process for managing an inventory management system. At 302, a computing device may receive a stock acquisition request for an item from a commodity trading system. The stock acquisition request may include the location information and/or the address information of the user. In implementations, the item may be related to appliances. It should be noted that the item is not limited to household appliances, but also other kinds of goods and/or service, such as home appliances, audio books, apparel, electronic products and household department stores. This is not limited by the present disclosure.

The stock acquisition request may include the location information and/or the address information of the user. The computing device may obtain the inventory information of the item based on the location information and/or the address information. The location information may include at least one of IP address information, GPS location information, or location information of a base station. In addition, the location information may include other data to determine location information of the user. The address information may include a shipping address of the user and other data to determine geographic information of the user. This is not limited by the present disclosure.

At 304, the computing device may parse the location information and/or the address information of the user from the stock acquisition request.

At 306, the computing device may obtain a logistics warehouse list including multiple logistics warehouses covering the location information and/or the address information of the user. The logistics warehouses may include logistics main warehouses and the logistics sub-warehouses. The logistics main warehouses may receive and store information of items, and allot items to the logistics sub-warehouses. The logistics sub-warehouse may receive the allotted items and process the order for shipping.

In implementations, the logistics warehouse refers to the logistics sub-warehouse. For any logistics warehouse, they have respective distribution area. The area covers location information and/or address information of multiple users. For each user, the user may located within multiple logistics warehouses corresponding to the location information and/or the address information. In implementations, among these logistics warehouses, the computing device may select one logistics warehouse as the shipping logistics warehouse, as described as follow.

At 308, the computing device may select a logistics warehouse form the multiple logistics warehouses that has a shortest distance from a location indicated in the location information and/or the address information of the user, and designate the logistics warehouse as a candidate logistics warehouse.

Together with the operation 306, the computing device may select a shipping logistics warehouse for the item among the logistics warehouses in the logistics warehouse list. At operations 304 and 306, the computing device may obtain a logistics warehouse list including multiple logistics warehouses covering the location information and/or the address information of the user, and the computing device may select the logistics warehouse from the logistics warehouse list for shipping the order.

In implementations, the computing device may select a logistics warehouse form the multiple logistics warehouses that has the shortest distance from a location indicated in the location information and/or the address information of the user and designate the logistics warehouse as a candidate logistics warehouse. This effectively reduces the shipping cost of the item. For example, shipping home appliances may need large shipping vesicles. The closest logistics warehouse may reduce freight loss.

At 310, the computing device may obtain inventory information of the candidate logistics warehouse. The operations 302 to 306 include receipt of the stock acquisition request, parsing of the stock acquisition request, obtaining of the logistics warehouse list, and selection of the candidate logistics warehouse. These operations may facilitate transmission of the inventory information to the commodity trading system. The inventory information of the candidate logistics warehouse may be obtained, as described as follow.

In implementations, the inventory information may be returned to the computing device. The inventory information may include real stocking information and virtual stocking information. The implementations not only relate to the spot sales mode but also to future sales model. For example, for the online mall in home appliances, users can not only directly purchase items in stock and make payment, but also pay a deposit for the home appliances and make payment later on.

Different sales model correspond to different stocking methods. One is actual existence of the inventory information in the logistics warehouse, namely: real inventory information corresponding to the spot sales model. Another one is non-existence of the inventory information in logistics warehouse, namely: virtual inventory information corresponding to the spot sales model. The virtual inventory information may indicate a number of sales determined by the merchant before the item is out of the manufacturer.

The implementations further relate to obtaining warehouse identification information. The computing device may further transmit the warehouse identification information to the commodity trading system. The warehouse identification information may include a warehouse code of the candidate logistics warehouse. The purpose of transmitting warehouse identification information to the commodity trading system is provided as follow.

The inventory information of the candidate logistics warehouse may be obtained and transmitted to the commodity trading system. In other words, the user has paid the item.

The commodity trading system may not be able to determine a corresponding logistics warehouse after the commodity trading system generates the real inventory logistics order or the virtual stock trading order. In these instances, the computing device may obtain the warehouse identification information of the candidate logistics warehouse and transmit the warehouse identification information to the commodity trading system.

The computing device may further transmit the warehouse code of the candidate logistics warehouse to the commodity trading system. The commodity trading system may record the real inventory logistics order or the virtual inventory order. The computing device may transmit the real inventory logistics order or the virtual inventory order to the logistics management system. The logistics management system may proceed shipping of the item on the real inventory logistics order or the virtual inventory order based on the warehouse code.

At 312, the computing device transmits the inventory information to the commodity trading system. The computing device may obtain the inventory information of the candidate logistics warehouse and forward to the inventory information to the commodity trading system. In these instances, the computing device may transmit the inventory information to the commodity trading system, obtain the warehouse identification information of the candidate logistics warehouse, and transmit the warehouse identification information to the commodity trading system. Further, the computing device may store the inventory information of the candidate logistics warehouse for the next stock acquisition request. The inventory information (e.g., all the information store in databases for all the home appliances) may be updated and the updated inventory information may further transmitted to the commodity trading system.

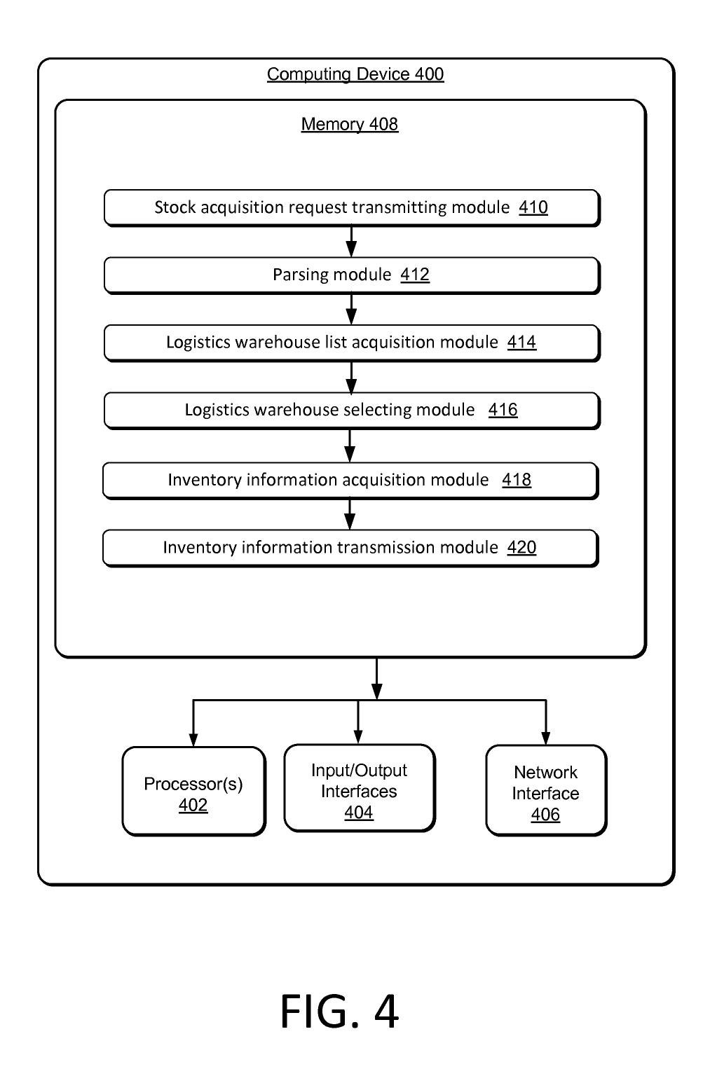

FIG. 4 is a schematic diagram of an illustrative computing architecture that enable managing an inventory management system. The computing device 400 may be a user device or a server for processing transactions. In one exemplary configuration, the computing device 400 may include one or more processors 402, input/output interfaces 404, network interface 406, and memory 408.

The memory 408 may include computer-readable media in the form of volatile memory, such as random-access memory (RAM) and/or non-volatile memory, such as read only memory (ROM) or flash RAM. The memory 408 is an example of computer-readable media.

Computer-readable media may include volatile and non-volatile, removable and non-removable media implemented in any method or technology for storage of information such as computer readable instructions, data structures, program modules, or other data. Examples of computer storage media include, but are not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. As defined herein, computer-readable media does not include transitory media such as modulated data signals and carrier waves.

Turning to the memory 408 in more detail, the memory 408 may include a stock acquisition request transmitting module 410, a parsing module 412, a logistics warehouse list acquisition module 414, a logistics warehouse selecting module 416, an inventory information acquisition module 418, and an inventory information transmission module 420.

The stock acquisition request transmitting module 410 may be configured to receive a stock acquisition request for an item from a commodity trading system. The stock acquisition request includes the location information and/or the address information of the user.

The parsing module 412 may be configured to parse the location information and/or the address information of the user from the stock acquisition request.

The logistics warehouse list acquisition module 414 may be configured to obtain a logistics warehouse list including multiple logistics warehouses covering the location information and/or the address information of the user.

The logistics warehouse selecting module 416 may be configured to select a logistics warehouse form the multiple logistics warehouses that has a shortest distance from a location indicated in the location information and/or the address information of the user, and designate the logistics warehouse as a candidate logistics warehouse.

The inventory information acquisition module 418 may be configured to obtain inventory information of the candidate logistics warehouse.

The inventory information transmission module 420 may be configured to transmit the inventory information to the commodity trading system.

In implementations, the inventory managing system may include a warehouse identification information acquisition module configured to obtain warehouse identification information of the candidate logistics warehouse, and a warehouse identification information transmission module configured to transmit the warehouse identification information to the commodity trading system. In implementations, a stock information update module may be configured to update the inventory information of the candidate logistics warehouse.

The implementations herein relate to methods and systems for managing logistics order systems, inventory system, and/or commodity trading system, which may cooperate with each other.

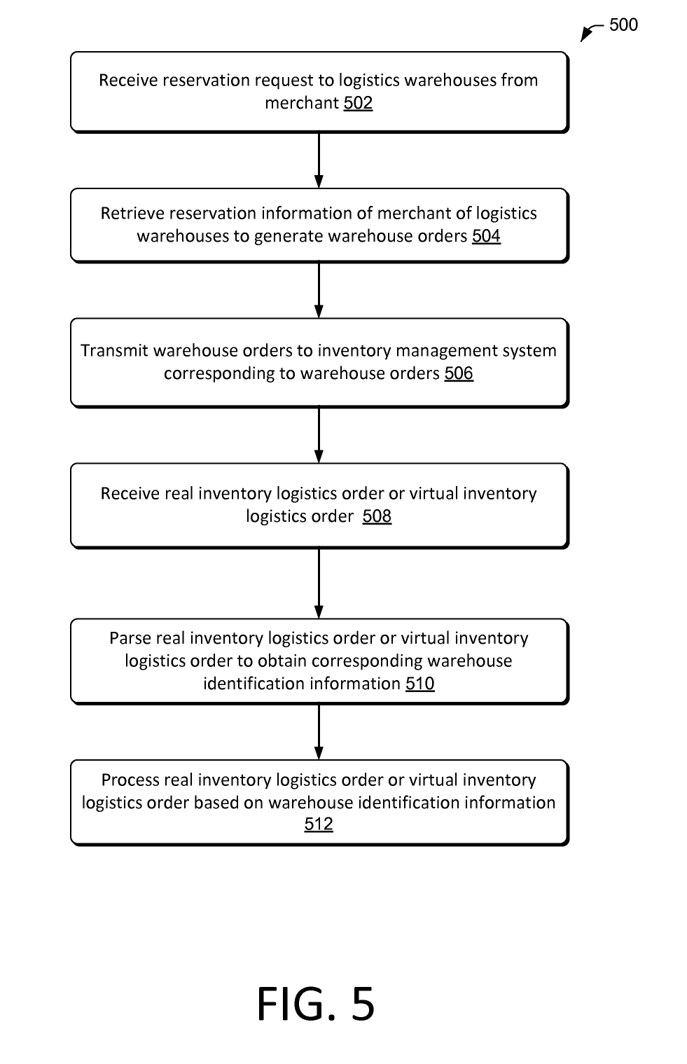

FIG. 5 is a flow chart of an illustrative process for managing logistics orders. At 502, a computing device receives a reservation request to logistics warehouses from a merchant. In implementations, the item may be related to appliances. It should be noted that the item is not limited to household appliances, but also other kinds of goods and/or service, such as home appliances, audio books, apparel, electronic products and household department stores. This is not limited by the present disclosure.

In implementations, the merchant may include a manufacturer of the item and/or an online seller associated with the item. The merchant may generate and send the reservation request of the item. The logistics warehouses may include logistics main warehouses and the logistics sub-warehouses. The logistics main warehouses may receive and store information of items, and allot items to the logistics sub-warehouses.

The logistics sub-warehouse may receive the allotted items and process the order for shipping. The computing device may receive the reservation request to the logistics main warehouses from the merchant and receive the reservation request to the logistics sub-warehouse from the merchant. When receiving the reservation request to the logistics sub-warehouse from the merchant, the computing device may receive the reservation request to the logistics sub-warehouse and the reservation request to the logistics main warehouse. In other words, when ordering items from the logistics warehouses, a user may order from the logistics main warehouses and the logistics sub-warehouses.

When the item enters the inventory, the item enters logistics main warehouse. The logistics main warehouses may allot items to the logistics sub-warehouses each having a shipping coverage. This reduces the logistics cost of shipment processing and avoids a problem under conventional technique: temporarily allotting the item.

At 504, the computing device retrieves reservation information of the merchant of the logistics warehouses to generate warehouse orders. The warehouse orders may include real warehouse orders and virtual warehouse orders. The reservation information may include the sale number of the item in the logistics sub-warehouse and the logistics main warehouse.

The real warehouse orders refer to orders of the real inventory that are reserved by the merchant for the logistics warehouse. The virtual warehouse orders refer to orders of the virtual inventory that are reserved by the merchant for the logistics warehouse. Among them, the real stock refers to a stock number of the item for the spot sales model. The virtual stock refers to a sale number of the item for the future sales model.

At 506, the computing device transmits the warehouse orders to an inventory management system corresponding to the warehouse orders. The inventory managing system may process the entry of the real warehouse orders and the virtual warehouse orders. The inventory managing system may generate and transmit confirmation of the entry of the real warehouse orders and the virtual warehouse orders to other systems.

The computing device may transmit the warehouse orders to the inventory management system corresponding to the warehouse orders. The inventory managing system may the process the entry of the real warehouse orders and the virtual warehouse orders, and then return for confirmation.

At 508, the computing device receives a real inventory logistics order or a virtual inventory logistics order. The real stock trading order and the real inventory logistics order may correspond to the spot sales model. The real stock trading order may differ from the virtual stock trading orders and the virtual inventory logistics order. The virtual stock trading orders and the virtual inventory logistics order may correspond to the future sales model.

At operations 510 and 512, the computing device processes the shipping of the real inventory logistics order and the virtual inventory logistics order.

At 510, the computing device parses the real inventory logistics order or the virtual inventory logistics order to obtain corresponding warehouse identification information. The warehouse identification information may include a warehouse code of the candidate logistics warehouse. The warehouse identification information may be used to determine the logistics warehouse corresponding to the item. Other information may also be used to determine the corresponding relationship between the item and the logistics warehouse. This is not limited by the present disclosure. In some instances, the computing device may determine the real stock corresponding to the real inventory logistics order or the virtual inventory logistics order based on the warehouse code.

At 512, the computing device processes the real inventory logistics order or the virtual inventory logistics order based on the warehouse identification information. The shipping of the real inventory logistics order may include the following implementations. (1) The computing device may receive a stocking confirmation of the warehouse order from the inventory management system. (2) The computing device may update the real inventory information of the item in the logistics warehouses corresponding to the real warehouse orders. (3) The computing device may transmit the real inventory logistics order to the real stock corresponding to the warehouse code.

The shipping of the virtual inventory logistics order may include the following implementations. (1) The computing device may receive a stocking confirmation of the warehouse virtual order from the inventory management system. (2) The computing device may update the virtual inventory information of the item in the logistics warehouses corresponding to the virtual warehouse orders. (3) The computing device may generate a message indicating that the virtual inventory logistics order is in stock. (4) The computing device may parse virtual inventory identification information of the virtual inventory logistics order from the virtual inventory logistics order after receiving the message. (5) The computing device may determine a shipping order based on the virtual inventory identification information of the virtual inventory logistics order. The computing device may transmit the virtual inventory logistics order to the virtual stock corresponding to the warehouse code.

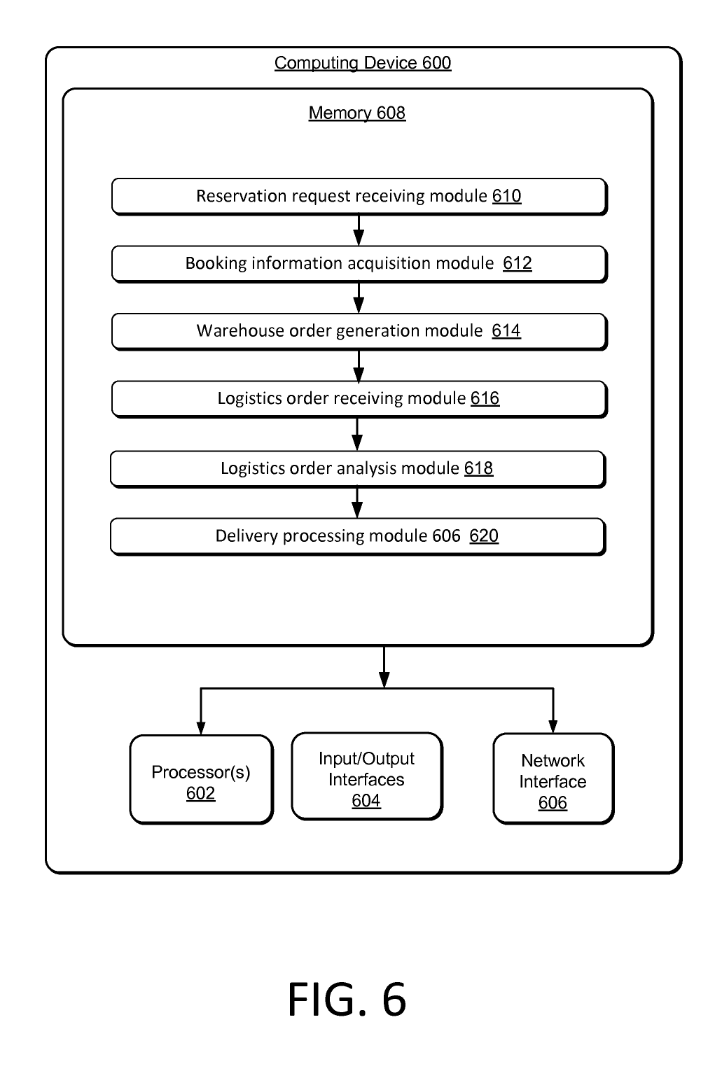

FIG. 6 is a schematic diagram of an illustrative computing architecture that enable managing logistics orders. The computing device 600 may be a user device or a server for processing transactions. In one exemplary configuration, the computing device 600 may include one or more processors 602, input/output interfaces 604, network interface 606, and memory 608.

The memory 608 may include computer-readable media in the form of volatile memory, such as random-access memory (RAM) and/or non-volatile memory, such as read only memory (ROM) or flash RAM. The memory 608 is an example of computer-readable media.

Computer-readable media may include volatile and non-volatile, removable and non-removable media implemented in any method or technology for storage of information such as computer readable instructions, data structures, program modules, or other data. Examples of computer storage media include, but are not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. As defined herein, computer-readable media does not include transitory media such as modulated data signals and carrier waves.

Turning to the memory 608 in more detail, the memory 608 may include a reservation request receiving module 610, a booking information acquisition module 612, a warehouse order generation module 614, a logistics order receiving module 616, a logistics order analysis module 618, and a delivery processing module 620.

The reservation request receiving module 610 may be configured to receive a reservation request to logistics warehouses from a merchant. The booking information acquisition module 612 may be configured to retrieve reservation information of the merchant of the logistics warehouses to generate warehouse orders. The warehouse orders may include real warehouse orders and virtual warehouse orders. The warehouse order generation module 614 may be configured to transmit the warehouse orders to an inventory management system corresponding to the warehouse orders.

The logistics order receiving module 616 may be configured to receive a real inventory logistics order or a virtual inventory logistics order. The logistics order analysis module 618 may be configured to parse the real inventory logistics order or the virtual inventory logistics order to obtain corresponding warehouse identification information. The delivery processing module 620 may be configured to process the real inventory logistics order or the virtual inventory logistics order based on the warehouse identification information.

In implementations, the memory may further include a warehousing confirmation message receiving module configured to receive a stocking confirmation of the warehouse order or the virtual warehouse orders from the inventory management system;

In implementations, the memory may further include an inventory updating module configured to update the inventory information of the item in the logistics warehouses corresponding to the real warehouse orders or the virtual warehouse orders. The inventory information may include real stocking information and virtual stocking information.

Although the preferred embodiments disclosed above, but it is not intended to limit the application of any person skilled in the art without departing from the spirit and scope of this disclosure, you can make changes and modifications may, therefore this disclosure wide scope of protection of the claims should be defined prevail.

The embodiments are merely for illustrating the present disclosure and are not intended to limit the scope of the present disclosure. It should be understood for persons in the technical field that certain modifications and improvements may be made and should be considered under the protection of the present disclosure without departing from the principles of the present disclosure.

What is claimed is:

1. A method for processing transactions, the method comprising:
receiving, by one or more processors of a computing device, a transaction request for an item from a user device associated with a user;
obtaining, by the one or more processors, location information or address information of the user;
transmitting, by the one or more processors, a stock acquisition request for the item to an inventory management system, the stock acquisition request including the location information or the address information of the user;
receiving, by the one or more processors, inventory information from the inventory management system;
determining, by the one or more processors, whether the item is in real stock or virtual stock based on the inventory information;
generating, by the one or more processors, a corresponding trading order and a corresponding logistics order if the item is in real stock or virtual stock; and
transmitting, by the one or more processors, the logistics order to a logistics management system.

2. The method of claim 1, wherein the determining that the item is in real stock or virtual stock based on the inventory information, and the generating the corresponding trading order and the corresponding logistics order if the item is in real stock or virtual stock comprise:
determine whether the item is in real stock based on the inventory information;
generating a real stock trading order and a real inventory logistics order for the item if the item is in real stock;
determining whether the item is in virtual stock based on the inventory information if the item is not in real stock; and
generating a virtual stock trading order and a virtual inventory logistics order for the item if the item is in virtual stock.

3. The method of claim 2, wherein the real stock trading order or the real inventory logistics order comprises warehouse identification information corresponding to the item.

4. The method of claim 2, wherein the virtual stock trading order and the virtual inventory logistics order comprise virtual inventory identification information and the warehouse identification information that corresponds to the item, and wherein the virtual inventory identification information comprises a tag indicating a shipping order of the virtual inventory logistics order.

5. The method of claim 1, wherein the inventory information comprises real stocking information and virtual stocking information.

6. The method of claim 1, wherein the location information comprises at least one of Internet Protocol (IP) address information, Global Positioning System (GPS) location information, or location information of a base station.

7. The method of claim 1, wherein the address information comprises a shipping address of the user.

8. One or more computer-readable media storing executable instructions that, when executed by one or more processors, cause the one or more processors to perform acts comprising:
receiving a stock acquisition request for an item from a commodity trading system, the stock acquisition request including location information or address information of a user;
parsing the location information or the address information of the user from the stock acquisition request;
obtaining a logistics warehouse list including a plurality of logistics warehouses covering the location information or the address information of the user;
selecting a logistics warehouse form the plurality of logistics warehouses that has a shortest distance from a location indicated in the location information or the address information of the user;
designating the logistics warehouse as a candidate logistics warehouse;
obtaining inventory information of the candidate logistics warehouse; and
transmitting the inventory information to the commodity trading system.

9. The one or more computer-readable media of claim 8, the acts further comprising:
obtaining warehouse identification information of the candidate logistics warehouse; and
transmitting the warehouse identification information to the commodity trading system.

10. The one or more computer-readable media of claim 9, wherein the warehouse identification information comprises a warehouse code of the candidate logistics warehouse.

11. The one or more computer-readable media of claim 8, the acts further comprising updating the inventory information of the candidate logistics warehouse for a next stock acquisition request after transmitting the inventory information to the commodity trading system.

12. The computer-readable media of claim 8, wherein the location information comprises at least one of Internet Protocol (IP) address information, Global Positioning System (GPS) location information, or location information of a base station, and wherein the address information comprises a shipping address of the user.

13. The computer-readable media of claim 8, wherein transmitting the inventory information to the commodity trading system is performed after the user has made a payment for the item.

14. A system comprising:
one or more processors; and
memory to maintain a plurality of components executable by the one or more processors, the plurality of components comprising:
a reservation request receiving module configured to receive a reservation request to logistics warehouses from a merchant,
a booking information acquisition module configured to retrieve reservation information of the merchant of the logistics warehouses to generate a plurality of warehouse orders, the warehouse orders comprising real warehouse orders and virtual warehouse orders,
a warehouse order generation module configured to transmit the plurality of warehouse orders to an inventory management system corresponding to the plurality of warehouse orders,
a logistics order receiving module configured to receive a real inventory logistics order or a virtual inventory logistics order,
a logistics order analysis module configured to parse the real inventory logistics order or the virtual inventory logistics order to obtain corresponding warehouse identification information, and
a delivery processing module configured to process the real inventory logistics order or the virtual inventory logistics order based on the corresponding warehouse identification information.

15. The logistics management system of claim 14, wherein the plurality of components further comprise a warehousing confirmation message receiving module configured to receive respective stocking confirmation of the real warehouse orders or the virtual warehouse orders from the inventory management system.

16. The system of claim 15, wherein the plurality of components further comprise an inventory updating module configured to update inventory information of an item in the logistics warehouses corresponding to the real warehouse orders or the virtual warehouse orders, the inventory information comprising real stocking information and virtual stocking information.

17. The system of claim 14, wherein the logistics warehouses comprises logistics main warehouses and logistics sub-warehouses.

18. The system of claim 17, wherein the reservation request receiving module is further configured to receive a particular reservation request to the logistics main warehouses or the logistics sub-warehouse from the merchant.

19. The system of claim 14, wherein the logistics order analysis module is further configured to parse virtual inventory identification information of the virtual inventory logistics order from the virtual inventory logistics order after receiving a message indicating that the virtual inventory logistics order is in stock, and determine a shipping order based on the virtual inventory identification information of the virtual inventory logistics order.

20. The system of claim 19, wherein the virtual inventory identification information comprises a tag indicating the shipping order of the virtual inventory logistics order.
